(19) United States
(12) Patent Application Publication
(10) Pub. No.: US 2021/0111954 A1
(43) Pub. Date: Apr. 15, 2021

(54) METHOD AND APPARATUS OF CONFIGURING OPERATING MODE FOR MULTI-MODE TERMINAL

(71) Applicant: BEIJING XIAOMI MOBILE SOFTWARE CO., LTD., BEIJING (CN)

(72) Inventor: Wei HONG, Beijing (CN)

(73) Assignee: BEIJING XIAOMI MOBILE SOFTWARE CO., LTD., BEIJING (CN)

(21) Appl. No.: 16/610,229

(22) PCT Filed: May 4, 2017
(86) PCT No.: PCT/CN2017/083048

§ 371 Date: Nov. 1, 2019

(51) Int. Cl. H04L 12/24; H04W 8/24; H04W 24/10; H04W 76/27; H04W 80/02; H04W 88/06

(52) U.S. Cl. CPC H04L 41/0813; H04W 8/245; H04W 88/06; H04W 76/27; H04W 80/02; H04W 24/10

(57) ABSTRACT

A method of configuring an operating mode for a multi-mode terminal includes: a target operating mode matching the multi-mode terminal is determined from among a plurality of operating modes reported and supported by the multi-mode terminal; target network configuration information corresponding to the target operating mode is determined; and the target network configuration information is sent to the multi-mode terminal, so that the multi-mode terminal operates in the target operating mode after performing network configuration according to the target network configuration information. A base station determines, from among the plurality of the operating modes supported by the multi-mode terminal, the target operating mode matching the multi-mode terminal, and sends target network configuration information corresponding to the target operating mode to the multi-mode terminal, so as to achieve a purpose of dynamically configuring the operating mode for the multi-mode terminal.

### TECHNICAL FIELD

The present disclosure relates to the field of communications, and in particular to methods and apparatuses of configuring an operating mode for a multi-mode terminal.

### BACKGROUND

Standardization relating to the 5G-NR (New Radio) system is being carried out in the 3rd Generation Partnership Project (3GPP). In the 5G system, a multi-mode terminal can support different operating modes, e.g., different numerologies, and the different operating modes correspond respectively to different terminal capabilities or different supportable network configurations and services.

However, no method of configuring an appropriate operating mode for a multi-mode terminal has been proposed.

### SUMMARY

To overcome problems existing in the related art, a method and an apparatus of configuring an operating mode for a multi-mode terminal are provided by examples of the present disclosure.

According to a first aspect of examples of the present disclosure, a method of configuring an operating mode for a multi-mode terminal is provided, which is applied to a base station and includes:

determining, from among a plurality of operating modes supported by the multi-mode terminal which are reported from the multi-mode terminal, a target operating mode matching the multi-mode terminal;

determining target network configuration information corresponding to the target operating mode; and

sending the target network configuration information to the multi-mode terminal, so that the multi-mode terminal operates in the target operating mode after performing network configuration according to the target network configuration information.

Optionally, determining, from among the plurality of the operating modes supported by the multi-mode terminal which are reported from the multi-mode terminal, the target operating mode matching the multi-mode terminal, includes:

determining a current service requirement of the multi-mode terminal; and

determining, from among the plurality of the operating modes supported by the multi-mode terminal which are reported from the multi-mode terminal, the target operating mode matching the service requirement.

Optionally, determining, from among the plurality of the operating modes supported by the multi-mode terminal which are reported from the multi-mode terminal, the target operating mode matching the multi-mode terminal, includes:

determining a target link with the best link quality from among a plurality of links according to current link qualities of the plurality of the links; and

determining, from among the plurality of the operating modes supported by the multi-mode terminal which are reported from the multi-mode terminal, the target operating mode matching the target link.

Optionally, determining the target network configuration information corresponding to the target operating mode includes:

determining the target network configuration information corresponding to the target operating mode, according to a pre-defined correspondence between operating mode and network configuration information,

where the network configuration information includes at least one of the following:

configuration information of a media access control layer, configuration information of a radio link control layer, or configuration information of a packet data convergence protocol layer.

Optionally, sending the target network configuration information to the multi-mode terminal includes:

sending the target network configuration information to the multi-mode terminal through radio resource control signaling.

Optionally, after determining the target operating mode matching the multi-mode terminal, the method further includes:

determining a target index number corresponding to the target operating mode, according to a pre-defined correspondence between operating mode and index number; and

sending the target index number to the multi-mode terminal, so that the multi-mode terminal operates in the target operating mode after performing network configuration according to target network configuration information corresponding to the target index number based on a pre-defined correspondence between index number and network configuration information.

According to a second aspect of examples of the present disclosure, a method of configuring an operating mode for a multi-mode terminal is provided, which is applied to the multi-mode terminal and includes:

reporting a plurality of operating modes supported by the multi-mode terminal to a base station;

receiving target network configuration information sent by the base station, wherein the target network configuration information is network configuration information corresponding to a target operating mode, and the target operating mode is an operating mode matching the multi-mode terminal which is determined by the base station from among the plurality of the operating modes; and

after performing network configuration according to the target network configuration information, operating in the target operating mode.

Optionally, after reporting the plurality of the operating modes supported by the multi-mode terminal to the base station, the method further includes:

receiving a target index number sent by the base station, wherein the target index number is an index number corresponding to a target operating mode, and the target operating mode is an operating mode matching the multi-mode terminal which is determined by the base station from among the plurality of the operating modes;

determining target network configuration information corresponding to the target index number, according to a pre-defined correspondence between index number and network configuration information; and

upon determining the target network configuration information, performing the operation of operating in the target operating mode after performing the network configuration according to the target network configuration information.

According to a third aspect of examples of the present disclosure, an apparatus of configuring an operating mode for a multi-mode terminal is provided, which is applied to a base station, and includes:

an operating mode determining module, configured to determine, from among a plurality of operating modes supported by the multi-mode terminal which are reported from the multi-mode terminal, a target operating mode matching the multi-mode terminal;

a first network configuration information determining module, configured to determine target network configuration information corresponding to the target operating mode; and

a first sending module, configured to send the target network configuration information to the multi-mode terminal, so that the multi-mode terminal operates in the target operating mode after performing network configuration according to the target network configuration information.

Optionally, the operating mode determining module includes:

a service requirement determining sub-module, configured to determine a current service requirement of the multi-mode terminal; and

a first operating mode determining sub-module, configured to determine, from among the plurality of the operating modes supported by the multi-mode terminal which are reported from the multi-mode terminal, the target operating mode matching the service requirement.

Optionally, the operating mode determining module includes:

a link quality determining sub-module, configured to determine a target link with the best link quality from among a plurality of links according to current link qualities of the plurality of the links; and

a second operating mode determining sub-module, configured to determine, from among the plurality of the operating modes supported by the multi-mode terminal which are reported from the multi-mode terminal, the target operating mode matching the target link.

Optionally, the first network configuration information determining module includes:

a network configuration information determining sub-module, configured to determine the target network configuration information corresponding to the target operating mode, according to a pre-defined correspondence between operating mode and network configuration information,

where the network configuration information includes at least one of the following:

configuration information of a media access control layer, configuration information of a radio link control layer, or configuration information of a packet data convergence protocol layer.

Optionally, the first sending module includes:

a sending sub-module, configured to send the target network configuration information to the multi-mode terminal through radio resource control signaling.

Optionally, the apparatus further includes:

an index number determining module, configured to determine a target index number corresponding to the target operating mode, according to a pre-defined correspondence between operating mode and index number; and

a second sending module, configured to send the target index number to the multi-mode terminal, so that the multi-mode terminal operates in the target operating mode after performing network configuration according to target network configuration information corresponding to the target index number based on a pre-defined correspondence between index number and network configuration information.

According to a fourth aspect of examples of the present disclosure, an apparatus of configuring an operating mode for a multi-mode terminal is provided, which is applied to the multi-mode terminal and includes:

a reporting module, configured to report a plurality of operating modes supported by the multi-mode terminal to a base station;

a first receiving module, configured to receive target network configuration information sent by the base station, wherein the target network configuration information is network configuration information corresponding to a target operating mode, and the target operating mode is an operating mode matching the multi-mode terminal which is determined by the base station from among the plurality of the operating modes; and

a network configuring module, configured to operate in the target operating mode after performing network configuration according to the target network configuration information.

Optionally, the apparatus further includes:

a second receiving module, configured to receive a target index number sent by the base station, wherein the target index number is an index number corresponding to a target operating mode, and the target operating mode is an operating mode matching the multi-mode terminal which is determined by the base station from among the plurality of the operating modes;

a second network configuration information determining module, configured to determine target network configuration information corresponding to the target index number according to a pre-defined correspondence between index number and network configuration information; and

a controlling module, configured to, upon the second network configuration information determining module determines the target network configuration information, control the network configuring module toto operate in the target operating mode after performing the network configuration according to the target network configuration information.

According to a fifth aspect of examples of the present disclosure, a computer-readable storage medium is provided, where the storage medium storing a computer program for implementing the method of configuring an operating mode for a multi-mode terminal according to the first aspect.

According to a sixth aspect of examples of the present disclosure, a computer-readable storage medium is provided, where the storage medium storing a computer program for implementing the method of configuring an operating mode for a multi-mode terminal according to the second aspect.

According to a seventh aspect of examples of the present disclosure, an apparatus of configuring an operating mode for a multi-mode terminal is provided, which is applied to a base station and includes:

a processor; and

a memory storing instructions executable by the processor,

where the processor is configured to:

determine, from among a plurality of operating mode supported by the multi-mode terminal which are reported from the multi-mode terminal, a target operating mode matching the multi-mode terminal;

determine target network configuration information corresponding to the target operating mode; and

send the target network configuration information to the multi-mode terminal, so that the multi-mode terminal operates in the target operating mode after performing network configuration according to the target network configuration information.

According to an eighth aspect of examples of the present disclosure, an apparatus of configuring an operating mode for a multi-mode terminal is provided, which is applied to the multi-mode terminal and includes:

a processor; and

a memory storing instructions executable by the processor,

where the processor is configured to:

report a plurality of operating modes supported by the multi-mode terminal to a base station;

receive target network configuration information sent by the base station, wherein the target network configuration information is network configuration information corresponding to a target operating mode, and the target operating mode is an operating mode matching the multi-mode terminal which is determined by the base station from among the plurality of the operating modes; and

after performing network configuration according to the target network configuration information, operate in the target operating mode.

Technical solutions according to the examples of the present disclosure may include the following beneficial effects.

In an example of the present disclosure, the base station can determine the target operating mode matching the multi-mode terminal from among the plurality of the operating modes supported by the multi-mode terminal which are reported by the multi-mode terminal. Further, the base station can determine the target network configuration information corresponding to the target operating mode, and send the target network configuration information to the multi-mode terminal. Through the process, the base station can determine the target operating mode matching the multi-mode terminal from among the plurality of the operating modes supported by the multi-mode terminal and send the target network configuration information corresponding to the target operating mode to the multi-mode terminal, thereby achieving a purpose of dynamically configuring an operating mode for the multi-mode terminal.

In an example of the present disclosure, when determining the target operating mode matching the multi-mode terminal, the base station may take an operating mode matching the current service requirement of the multi-mode terminal from among the plurality of the operating modes supported by the multi-mode terminal as the target operating mode. Optionally, the base station may also take an operating mode matching the target link with the best link quality as the target operating mode according to current link states of the plurality of the links. Through the process, the base station may dynamically determine the target operating mode matching the multi-mode terminal in the plurality of the operating modes supported by the multi-mode terminal. Thus, availability thereof is high.

In an example of the present disclosure, the base station may send the target network configuration information corresponding to the target operating mode to the multi-mode terminal through the radio resource control signaling, which is convenient in implementation and high in availability.

In an example of the present disclosure, the base station may also send the target index number corresponding to the target operating mode to the multi-mode terminal after determining the target operating mode matching the multi-mode terminal. In this case, the multi-mode terminal may determine the target network configuration information corresponding to the target index number according to the pre-defined correspondence between index number and the network configuration information, thereby saving signaling resources between the base station and the multi-mode terminal.

In an example of the present disclosure, the multi-mode terminal can report the plurality of the operating modes supported by the multi-mode terminal to the base station, and the base station can determine the target operating mode matching the multi-mode terminal in the plurality of the operating modes. Further, the multi-mode terminal receives the target network configuration information that is returned by the base station and corresponds to the target operating mode, so that the multi-mode terminal can operate in the target operating mode after performing network configuration according to the target network configuration information. Through the process, a purpose of configuring a target operating mode matching the multi-mode terminal is achieved.

In an example of the present disclosure, the multi-mode terminal may also receive the target index number returned by the base station after reporting the plurality of the operating modes supported by the multi-mode terminal to the base station. Then the multi-mode terminal can determine the target network configuration information corresponding to the target index number according to the pre-defined correspondence between index number and network configuration information. The multi-mode terminal can operate in the target operating mode after performing network configuration according to the target network configuration information. Through the process, upon only receiving the target index number from the base station, the multi-mode terminal can determine the corresponding target network configuration information, thereby saving signaling resources between the base station and the multi-mode terminal.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating a method of configuring an operating mode for a multi-mode terminal according to an example.

FIG. 2 is a flowchart illustrating another method of configuring an operating mode for a multi-mode terminal according to an example.

FIG. 3 is a flowchart illustrating another method of configuring an operating mode for a multi-mode terminal according to an example.

FIG. 4 is a flowchart illustrating another method of configuring an operating mode for a multi-mode terminal according to an example.

FIG. 5 is a flowchart illustrating another method of configuring an operating mode for a multi-mode terminal according to an example.

FIG. 6 is a flowchart illustrating another method of configuring an operating mode for a multi-mode terminal according to an example.

FIG. 7 is a flowchart illustrating another method of configuring an operating mode for a multi-mode terminal according to an example.

FIG. 8 is a flowchart illustrating another method of configuring an operating mode for a multi-mode terminal according to an example.

FIG. 9 is a block diagram illustrating an apparatus of configuring an operating mode for a multi-mode terminal according to an example.

FIG. 10 is a block diagram illustrating another apparatus of configuring an operating mode for a multi-mode terminal according to an example.

FIG. 11 is a block diagram illustrating another apparatus of configuring an operating mode for a multi-mode terminal according to an example.

FIG. 12 is a block diagram illustrating another apparatus of configuring an operating mode for a multi-mode terminal according to an example.

FIG. 13 is a block diagram illustrating another apparatus of configuring an operating mode for a multi-mode terminal according to an example.

FIG. 14 is a block diagram illustrating another apparatus of configuring an operating mode for a multi-mode terminal according to an example.

FIG. 15 is a block diagram illustrating another apparatus of configuring an operating mode for a multi-mode terminal according to an example.

FIG. 16 is a block diagram illustrating another apparatus of configuring an operating mode for a multi-mode terminal according to an example.

FIG. 17 is a structural diagram illustrating an apparatus of configuring an operating mode for a multi-mode terminal according to an example.

FIG. 18 is a structural diagram illustrating another apparatus of configuring an operating mode for a multi-mode terminal according to an example.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein is and includes any and all possible combinations of one or more of the associated listed items.

It is to be understood that, although terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”.

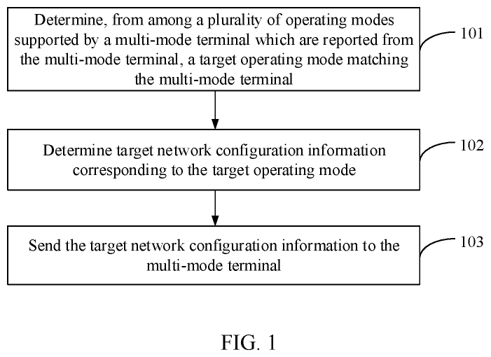

A method of configuring an operating mode for a multi-mode terminal is provided by examples of the present disclosure, and the method can be applied to a base station. FIG. 1 is a flowchart illustrating a method of configuring an operating mode for a multi-mode terminal according to an example, which can include the following steps.

At step 101, a target operating mode matching a multi-mode terminal is determined from among a plurality of operating modes supported by the multi-mode terminal which are reported from the multi-mode terminal.

At step 102, target network configuration information corresponding to the target operating mode is determined.

At step 103, the target network configuration information is sent to the multi-mode terminal, so that the multi-mode terminal operates in the target operating mode after performing network configuration according to the target network configuration information.

In the example, the base station can determine the target operating mode matching the multi-mode terminal from among the plurality of the operating modes supported by the multi-mode terminal which are reported from the multi-mode terminal. Further, the base station may determine the target network configuration information corresponding to the target operating mode, and send the target network configuration information to the multi-mode terminal. Through the process, the base station can determine the target operating mode matching the multi-mode terminal from among the plurality of the operating modes supported by the multi-mode terminal, and send the target network configuration information corresponding to the target operating mode to the multi-mode terminal, thereby achieving a purpose of dynamically configuring an operating mode for the multi-mode terminal.

For the above step 101, the base station may determine the target operating mode matching the multi-mode terminal from among the plurality of the supported operating modes supported by the multi-mode terminal in any of the following manners.

In a first manner, the target operating mode is determined according to a current service requirement of the multi-mode terminal.

FIG. 2 is a flowchart illustrating another method of configuring an operating mode for a multi-mode terminal according to the example shown in FIG. 1. In this manner, as shown in FIG. 2, step 101 may include the followings.

At step 101-11, the current service requirement of the multi-mode terminal is determined.

In examples of the present disclosure, the current service requirement of the multi-mode terminal may include at least one of the followings: a requirement of latency, a requirement of a carrier frequency band, and a requirement of a service scenario. At this step, the base station can acquire the current service requirement of the multi-mode terminal according to the related art.

At step 101-12, the target operating mode matching the service requirement is determined from among the plurality of the operating modes supported by the multi-mode terminal which are reported from the multi-mode terminal.

At this step, the base station may take an operating mode matching the service requirement in the plurality of the operating modes supported by the multi-mode terminal as the target operating mode matching the multi-mode terminal.

For example, the plurality of the operating modes supported by the multi-mode terminal include numerology A and numerology B. Upon the current service requirement of the multi-mode terminal is to ensure low latency and numerology B can satisfy the service requirement of the low latency, numerology B is the target operating mode.

For another example, the plurality of the operating modes supported by the multi-mode terminal include numerology A and numerology B, which correspond to two carrier frequency bands, e.g., frequency band 1 and frequency band 2 respectively. Upon the current service requirement of the multi-mode terminal is to operate with carrier frequency band 1, numerology A is the target operating mode.

The target operating mode may also be determined according to a current service scenario. For example, a 5G system includes three service scenarios, e.g., enhanced Mobile BroadBand (eMBB), massive Machine Type Communication (mMTC), and Ultra Reliable & Low Latency Communication (URLLC). The base station may also select an operating mode matching the current service scenario in the plurality of the operating modes supported by the multi-mode terminal as the target operating mode according to the current service scenario associated with the multi-mode terminal.

In a second manner, the base station determines the target operating mode according to current link qualities associated with a plurality of links.

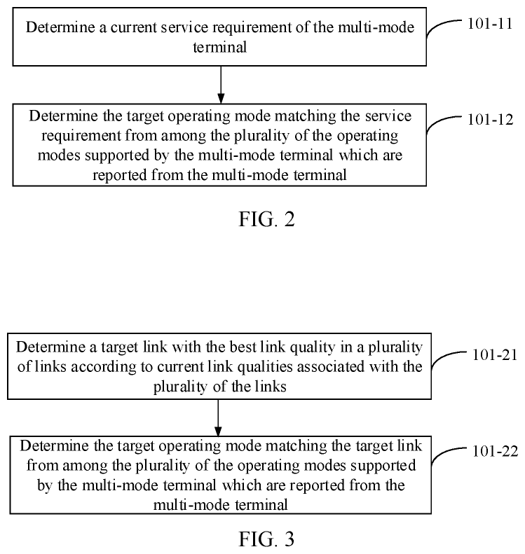

FIG. 3 is a flowchart illustrating another method of configuring an operating mode for a multi-mode terminal based on the example shown in FIG. 1. In this manner, as shown in FIG. 3, step 101 may include the followings.

At step 101-21, a target link with the best link quality is determined in a plurality of links according to the current link qualities of the plurality of the links.

In the related art, information such as Received Signal Strength Indication (RSSI), Signal Noise Ratio (SNR) and Bit Error Ratio (BER) may be used as link measurement information to measure the link quality.

At this step, the base station may acquire the above link measurement information according to the related art, and determine the target link with the best link quality in the plurality of the links according to the link measurement information.

For example, in the 5G system, the multi-mode terminal may support a New Radio (NR) mode and an enhanced Long Term Evolution (eLTE) mode. The base station may determine the link qualities of two links, i.e., NR and eLTE, according to the above link measurement information of the two links, and take a link with the best link quality as the target link.

At step 101-22, a target operating mode matching the target link is determined from among the plurality of the operating modes supported by the multi-mode terminal which are reported from the multi-mode terminal.

At this step, the base station may take an operating mode matching the target link as the target operating mode.

For example, if a NR link in the two links, i.e., the NR link and the eLTE link, has a better quality than the eLTE link, the target link is the NR link. In this case, the base station may directly take the NR mode as the target operating mode.

In an example, optionally, the base station may further determine a target operating mode better matching the multi-mode terminal based on the link quality and a load situation of each link.

For example, when the link quality of two links is determined by using at least one piece of the link measurement information and a difference between values of the piece of link measurement information associated with the two links is less than a preset threshold, it may be determined that the two links have close link quality levels. Thus, the base station may select a link with a less load as the target link, and further take an operating mode matching the target link as the target operating mode.

It is to be noted that when determining a target operating mode for the multi-mode terminal, the base station is generally a primary base station. Some micro secondary base stations cannot determine the target operating mode for the multi-mode terminal due to limited computing resources and service capabilities.

For the above step 102, the base station may determine the target network configuration information corresponding to the target operating mode according to a pre-defined correspondence between operating mode and network configuration information.

For example, the pre-defined correspondence between operating mode and network configuration information may be shown in Table 1.

TABLE 1

| Operating mode | Network configuration information |
|---|---|
| Operating mode 1 | Network configuration information 1 |
| Operating mode 2 | Network configuration information 2 |
| Operating mode 3 | Network configuration information 3 |
| . . . | . . . |

The network configuration information includes at least one of the following:

configuration information of a media access control layer, configuration information of a radio link control layer, or configuration information of a packet data convergence protocol layer.

At this step, after determining the target operating mode of the multi-mode terminal, the base station can determine the target network configuration information corresponding to the target operating mode according to Table 1.

For the above step 103, optionally, the base station may send the target network configuration information to the multi-mode terminal through radio resource control signaling.

After receiving the target network configuration information, the multi-mode terminal may correspondingly perform network configuration according to the target network configuration information based on the related art. Thus, the multi-mode terminal can operate in the target operating mode.

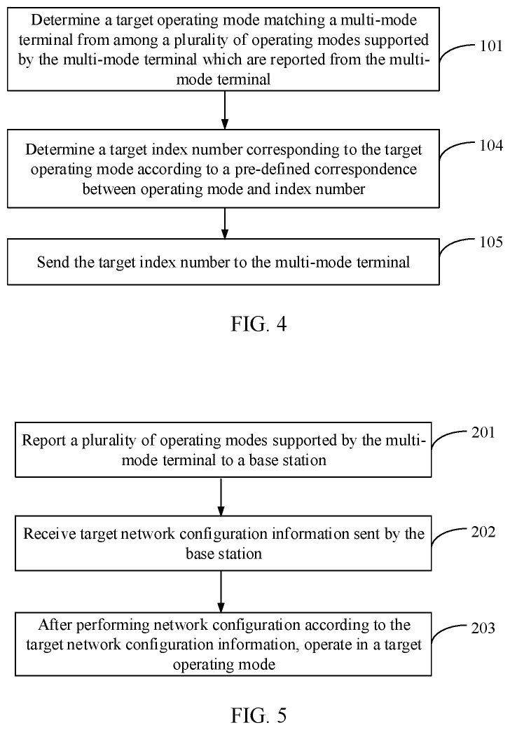

FIG. 4 is a flowchart illustrating another method of configuring an operating mode for a multi-mode terminal based on the example shown in FIG. 1. In an example, as shown in FIG. 4, after step 101 is completed, the method may further include the followings.

At step 104, a target index number corresponding to the target operating mode is determined according to a pre-defined correspondence between operating mode and index number.

In an example of the present disclosure, the correspondence between operating mode and index number may be shown in Table 2.

TABLE 2

| Operating mode | Index number |
|---|---|
| Operating mode 1 | Index number 1 |
| Operating mode 2 | Index number 2 |
| Operating mode 3 | Index number 3 |
| . . . | . . . |

At this step, the base station may determine the target index number corresponding to the target operating mode according to Table 2.

At step 105, the target index number is sent to the multi-mode terminal, so that the multi-mode terminal operates in the target operating mode after performing network configuration according to the target network configuration information corresponding to the target index number based on a pre-defined correspondence between index number and network configuration information.

At this step, the base station is only to send the target index number to the multi-mode terminal rather than send all target network configuration information to the multi-mode terminal through signaling. The multi-mode terminal pre-defines a correspondence between index number and network configuration information as shown in Table 3.

TABLE 3

| Index number | Network configuration information |
|---|---|
| Index number 1 | Network configuration information 1 |
| Index number 2 | Network configuration information 2 |
| Index number 3 | Network configuration information 3 |
| . . . | . . . |

Thus, the multi-mode terminal can determine the target network configuration information corresponding to the target index number according to Table 3. Therefore, after performing network configuration according to the target network configuration information, the multi-mode terminal can operate in the target operating mode.

In the example, after determining the target operating mode matching the multi-mode terminal, the base station may also send the target index number corresponding to the target operating mode to the multi-mode terminal, and then the multi-mode terminal can determine the target network configuration information by itself according to the target index number, thereby saving signaling resources between the base station and the multi-mode terminal.

Another method of configuring an operating mode for a multi-mode terminal is provided by examples of the present disclosure. The method can be applied to a multi-mode terminal. FIG. 5 is a flowchart illustrating another method of configuring an operating mode for a multi-mode terminal according to an example. As shown in FIG. 5, the method may include the following steps.

At step 201, a plurality of operating modes supported by the multi-mode terminal are reported to a base station.

At step 202, target network configuration information sent by the base station is received, where the target network configuration information is network configuration information corresponding to a target operating mode, and the target operating mode is an operating mode matching the multi-mode terminal which is determined by the base station from among the plurality of the operating modes.

At step 203, after performing network configuration according to the target network configuration information, the multi-mode terminal is operated in the target operating mode.

In the example, a multi-mode terminal can report a plurality of operating modes supported by the multi-mode terminal to a base station, so that the base station may determine target operating mode matching the multi-mode terminal from among the plurality of the operating modes. Further, the multi-mode terminal receives target network configuration information that is returned by the base station and corresponds to the target operating mode, and the multi-mode terminal can operate in the target operating mode after performing network configuration according to the target network configuration information. Through the process, a purpose of configuring a matching target operating mode for the multi-mode terminal is achieved.

For step 201, upon accessing the base station or after already accessed the base station, the multi-mode terminal may report the plurality of the operating modes supported by the multi-mode terminal to the base station according to the related art. As described above, the base station may determine the target operating mode matching the multi-mode terminal in the plurality of the operating modes according to a current service requirement of the multi-mode terminal or link qualities associated with a plurality of links.

For step 202, after determining the target operating mode, the base station can determine the target network configuration information corresponding to the target operating mode according to Table 1, and send the target network configuration information to the multi-mode terminal. The multi-mode terminal may directly receive the target network configuration information.

Optionally, the network configuration information includes configuration information of a media access control layer, configuration information of a radio link control layer, or configuration information of a packet data convergence protocol layer.

For step 203, the multi-mode terminal may perform network configuration for each network layer according to contents indicated by the target network configuration information. The multi-mode terminal can operate in the target operating mode after completing the network configuration.

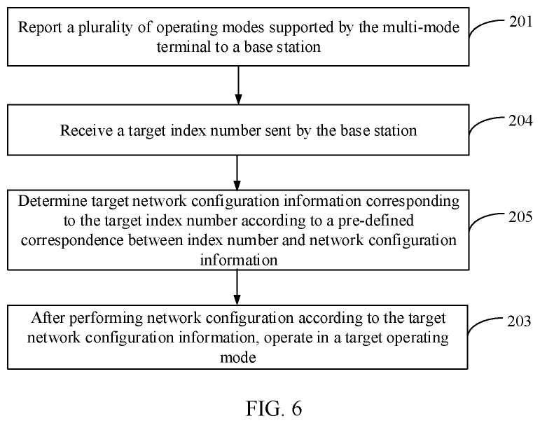

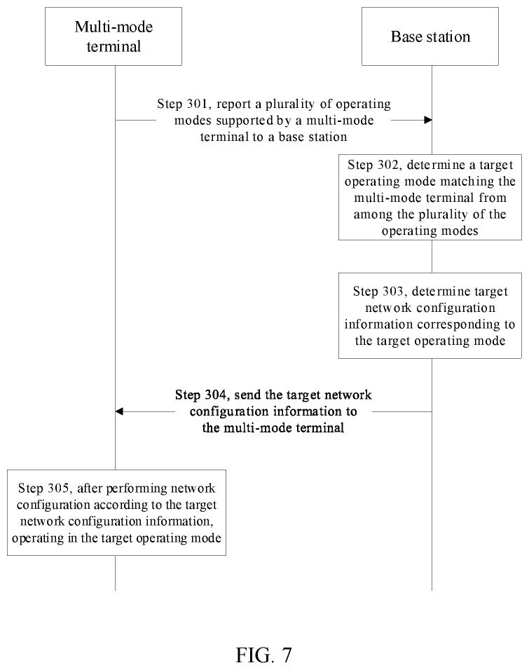

FIG. 6 is a flowchart illustrating another method of configuring an operating mode for a multi-mode terminal based on the example shown in FIG. 5. In an example, as shown in FIG. 6, after step 201 is completed, the method may further include the followings.

At step 204, a target index number sent by the base station is received, where the target index number is an index number corresponding to a target operating mode, and the target operating mode is an operating mode matching the multi-mode terminal which is determined by the base station from among the plurality of the operating modes.

At this step, the base station does not send target network configuration information to the multi-mode terminal. After determining the target operating mode matching the multi-mode terminal, the base station determines the target index number corresponding to the target operating mode according to Table 2, and then sends the target index number to the multi-mode terminal. The multi-mode terminal may directly receive the target index number.

At step 205, target network configuration information corresponding to the target index number is determined according to a pre-defined correspondence between index number and network configuration information.

At this step, the multi-mode terminal may determine the target network configuration information corresponding to the target index number according to pre-defined Table 3 after receiving the target index number.

Further, the multi-mode terminal may perform step 203 after completing step 205. At step 203, the multi-mode terminal operates in the target operating mode after performing network configuration according to the target network configuration information.

In the example, after reporting the plurality of the operating modes supported by the multi-mode terminal to the base station, the multi-mode terminal may receive the target index number returned by the base station. Then the multi-mode terminal can determine the target network configuration information corresponding to the target index number according to the pre-defined correspondence between index number and network configuration information. The multi-mode terminal can operate in the target operating mode after performing network configuration according to the target network configuration information. Through the process, upon only receiving the target index number sent by the base station, the multi-mode terminal can determine corresponding target network configuration information and perform the network configuration, thereby saving signaling resources between the base station and the multi-mode terminal.

Another method of configuring an operating mode for a multi-mode terminal is further provided by an example of the present disclosure. FIG. 7 is a flowchart illustrating a method of configuring an operating mode for a multi-mode terminal according to an example. As shown in FIG. 7, the method may include the following steps.

At step 301, a multi-mode terminal reports a plurality of operating modes supported by the multi-mode terminal to a base station.

At step 302, the base station determines a target operating mode matching the multi-mode terminal from among the plurality of the operating modes.

Optionally, the base station may take an operating mode matching a current service requirement of the multi-mode terminal in the plurality of the operating modes as the target operating mode. Or the base station may take an operating mode matching a target link with the best link quality in a plurality of links as the target operating mode.

At step 303, the base station determines target network configuration information corresponding to the target operating mode.

At this step, the base station determines the target network configuration information corresponding to the target operating mode according to pre-defined Table 1.

At step 304, the base station sends the target network configuration information to the multi-mode terminal.

At step 305, the multi-mode terminal operates in the target operating mode after performing network configuration according to the target network configuration information.

In the example, the base station can determine the target operating mode matching the multi-mode terminal, and determine the target network configuration information corresponding to the target operating mode. The multi-mode terminal can directly perform network configuration according to the target network configuration information sent by the base station. Thus, the multi-mode terminal operates in the target operating mode. Through the process, the purpose of configuring an operating mode for the multi-mode terminal is achieved.

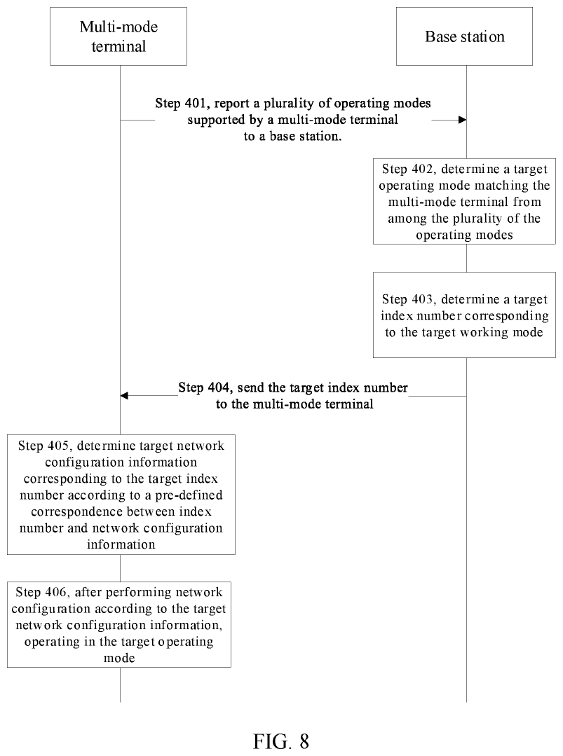

Another method of configuring an operating mode for a multi-mode terminal is further provided by an example of the present disclosure. FIG. 8 is a flowchart illustrating a method of configuring an operating mode for a multi-mode terminal according to an example. As shown in FIG. 8, the method may include the following steps.

At step 401, a multi-mode terminal reports a plurality of operating modes supported by the multi-mode terminal to a base station.

At step 402, the base station determines a target operating mode matching the multi-mode terminal from among the plurality of the operating modes.

Optionally, the base station may take an operating mode matching a current service requirement of the multi-mode terminal in the plurality of the operating modes as the target operating mode. Or the base station may take an operating mode matching a target link with the best link quality in a plurality of links as the target operating mode.

At step 403, the base station determines a target index number corresponding to the target operating mode.

At this step, the base station determines the target index number corresponding to the target operating mode according to the pre-defined Table 2.

At step 404, the base station sends the target index number to the multi-mode terminal.

At step 405, the multi-mode terminal determines target network configuration information corresponding to the target index number according to a pre-defined correspondence between index number and network configuration information.

At this step, the multi-mode terminal can determine the target network configuration information corresponding to the target index number according to pre-defined Table 3.

At step 406, after performing network configuration according to the target network configuration information, the multi-mode terminal operates in the target operating mode.

In the example, the base station can determine the target operating mode matching the multi-mode terminal, and determine the target index number corresponding to the target operating mode. The multi-mode terminal can acquire the target network configuration information according to the target index number sent by the base station, and then perform network configuration according to the target network configuration information. Thus, the multi-mode terminal operates in the target operating mode. Through the process, the signaling resources between the base station and the multi-mode terminal are saved while the purpose of configuring an operating mode for the multi-mode terminal is achieved.

Corresponding to the foregoing examples of methods of implementing application functions, the present disclosure further provides examples of apparatuses and corresponding terminals for implementing application functions.

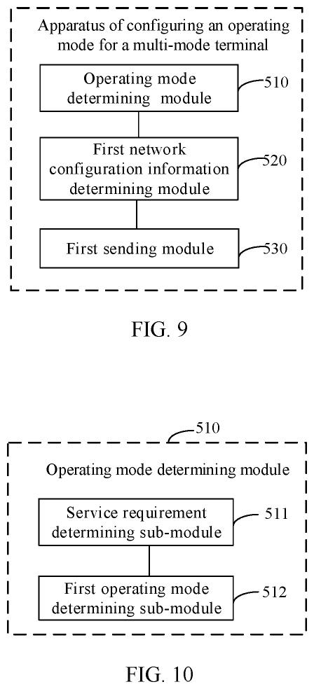

FIG. 9 is a block diagram illustrating an apparatus of configuring an operating mode for a multi-mode terminal according to an example. The apparatus is applied to a base station, and the apparatus includes:

an operating mode determining module 510, configured to determine, from among a plurality of operating modes supported by the multi-mode terminal which are reported from the multi-mode terminal, a target operating mode matching the multi-mode terminal;

a first network configuration information determining module 520, configured to determine target network configuration information corresponding to the target operating mode; and

a first sending module 530, configured to send the target network configuration information to the multi-mode terminal, so that the multi-mode terminal operates in the target operating mode after performing network configuration according to the target network configuration information.

FIG. 10 is a block diagram illustrating another apparatus of configuring an operating mode for a multi-mode terminal based on the example shown in FIG. 9. The operating mode determining module 510 includes:

a service requirement determining sub-module 511, configured to determine a current service requirement of the multi-mode terminal; and

a first operating mode determining sub-module 512, configured to determine, from among the plurality of the operating modes supported by the multi-mode terminal which are reported from the multi-mode terminal, the target operating mode matching the service requirement.

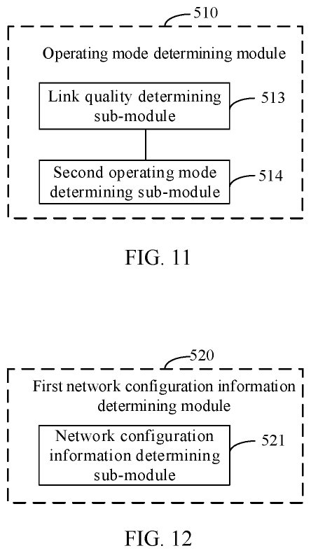

FIG. 11 is a block diagram illustrating another apparatus of configuring an operating mode for a multi-mode terminal based on the example shown in FIG. 9. The operating mode determining module 510 includes:

a link quality determining sub-module 513, configured to determine a target link with the best link quality from among a plurality of links according to current link qualities of the plurality of the links; and

a second operating mode determining sub-module 514, configured to determine, from among the plurality of the operating modes supported by the multi-mode terminal which are reported from the multi-mode terminal, the target operating mode matching the target link.

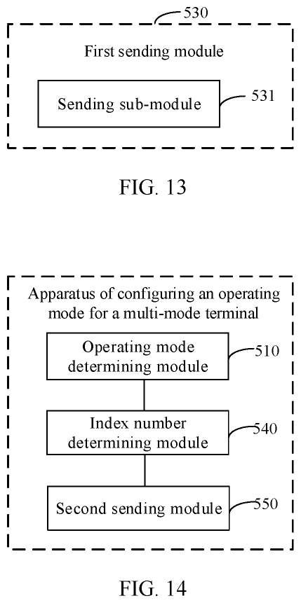

FIG. 12 is a block diagram illustrating another apparatus of configuring an operating mode for a multi-mode terminal based on the example shown in FIG. 9. The first network configuration information determining module 520 includes:

a network configuration information determining sub-module 521, configured to determine the target network configuration information corresponding to the target operating mode, according to a pre-defined correspondence between operating mode and network configuration information.

The network configuration information includes at least one of the following:

configuration information of a media access control layer, configuration information of a radio link control layer, or configuration information of a packet data convergence protocol layer.

FIG. 13 is a block diagram illustrating another apparatus of configuring an operating mode for a multi-mode terminal based on the example shown in FIG. 9. The first sending module 530 includes:

a sending sub-module 531, configured to send the target network configuration information to the multi-mode terminal through radio resource control signaling.

FIG. 14 is a block diagram illustrating another apparatus of configuring an operating mode for a multi-mode terminal based on the example shown in FIG. 9. The apparatus further includes:

an index number determining module 540, configured to determine a target index number corresponding to the target operating mode, according to a pre-defined correspondence between operating mode and index number; and

a second sending module 550, configured to send the target index number to the multi-mode terminal, so that the multi-mode terminal operates in the target operating mode after performing network configuration according to target network configuration information corresponding to the target index number based on a pre-defined correspondence between index number and network configuration information.

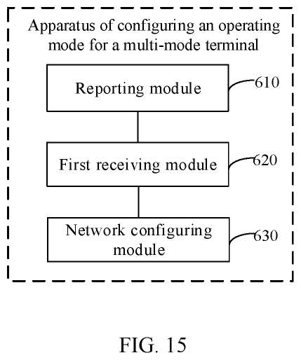

FIG. 15 is a block diagram illustrating another apparatus of configuring an operating mode for a multi-mode terminal according to an example of the present disclosure. The apparatus is applied to the multi-mode terminal and includes:

a reporting module 610, configured to report a plurality of operating modes supported by the multi-mode terminal to a base station;

a first receiving module 620, configured to receive target network configuration information sent by the base station, wherein the target network configuration information is network configuration information corresponding to a target operating mode, and the target operating mode is an operating mode matching the multi-mode terminal which is determined by the base station from among the plurality of the operating modes; and

a network configuring module 630, configured to operate in the target operating mode after performing network configuration according to the target network configuration information.

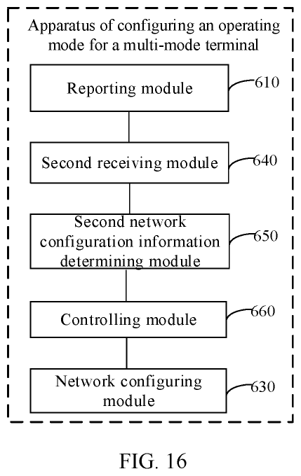

FIG. 16 is a block diagram illustrating another apparatus of configuring an operating mode for a multi-mode terminal based on the example shown in FIG. 15. The apparatus further includes:

a second receiving module 640, configured to receive a target index number sent by the base station, wherein the target index number is an index number corresponding to a target operating mode, and the target operating mode is an operating mode matching the multi-mode terminal which is determined by the base station from among the plurality of the operating modes;

a second network configuration information determining module 650, configured to determine target network configuration information corresponding to the target index number according to a pre-defined correspondence between index number and network configuration information; and

a controlling module 660, configured to, upon the second network configuration information determining module determines the target network configuration information, control the network configuring module toto operate in the target operating mode after performing the network configuration according to the target network configuration information.

Since the apparatus examples substantially correspond to the method examples, a reference may be made to part of the descriptions of the method examples for the related part. The apparatus examples described above are merely illustrative, where the units described as separate members may be or not be physically separated, and the members displayed as units may be or not be physical units, e.g., may be located in one place, or may be distributed to a plurality of network units. Part or all of the modules may be selected according to actual requirements to implement the objectives of the solutions in the examples. Those of ordinary skill in the art may understand and carry out them without creative work.

Correspondingly, an example of the present disclosure further provides a computer-readable storage medium storing a computer program. The computer program is used to implement any above method of configuring an operating mode for a multi-mode terminal, where the any method is applied to a base station.

Correspondingly, an example of the present disclosure further provides a computer-readable storage medium storing a computer program. The computer program is used to implement any above method of configuring an operating mode for a multi-mode terminal, where the any method is applied to the multi-mode terminal.

Correspondingly, an example of the present disclosure further provides an apparatus of configuring an operating mode for a multi-mode terminal. The apparatus is applied to a base station, including:

a processor; and

a memory storing instructions executable by the processor;

where the processor is configured to:

determine, from among a plurality of operating mode supported by the multi-mode terminal which are reported from the multi-mode terminal, a target operating mode matching the multi-mode terminal;

determine target network configuration information corresponding to the target operating mode; and

send the target network configuration information to the multi-mode terminal, so that the multi-mode terminal operates in the target operating mode after performing network configuration according to the target network configuration information.

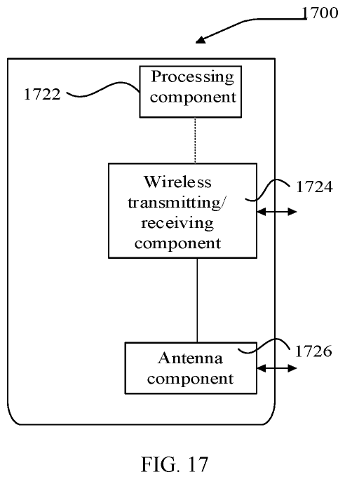

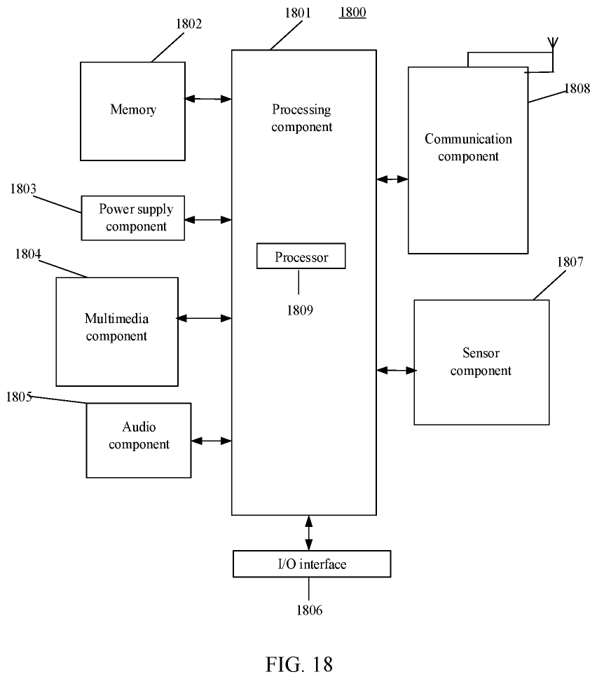

FIG. 17 is a schematic diagram illustrating a structure of an apparatus 1700 for configuring an operating mode for a multi-mode terminal according to an example of the present disclosure. The apparatus 1700 may be provided as a base station. As shown in FIG. 17, the apparatus 1700 includes a processing component 1722, a wireless transmitting/receiving component 1724, an antenna component 1726 and a signal processing part unique to a wireless interface. The processing component 1722 may further include one or more processors.

One processor of the processing component 1722 can be configured to:

determine, from among a plurality of operating mode supported by the multi-mode terminal which are reported from the multi-mode terminal, a target operating mode matching the multi-mode terminal;

determine target network configuration information corresponding to the target operating mode; and

send the target network configuration information to the multi-mode terminal, so that the multi-mode terminal operates in the target operating mode after performing network configuration according to the target network configuration information.

Correspondingly, an example of the present disclosure further provides an apparatus of configuring an operating mode for a multi-mode terminal. The apparatus is applied to the multi-mode terminal, including:

a processor; and

a memory storing instructions executable by the processor;

where the processor is configured to:

report a plurality of operating modes supported by the multi-mode terminal to a base station;

receive target network configuration information sent by the base station, wherein the target network configuration information is network configuration information corresponding to a target operating mode, and the target operating mode is an operating mode matching the multi-mode terminal which is determined by the base station from among the plurality of the operating modes; and

after performing network configuration according to the target network configuration information, operate in the target operating mode.

FIG. 18 is a schematic diagram illustrating a structure of an apparatus of configuring an operating mode for a multi-mode terminal according to an example. As shown in FIG. 18, an apparatus 1800 for configuring an operating mode for a multi-mode terminal is illustrated according to an example, and the apparatus 1800 may be a multi-mode terminal.

As shown in FIG. 18, the apparatus 1800 may include one or more of the following components: a processing component 1801, a memory 1802, a power supply component 1803, a multimedia component 1804, an audio component 1805, an input/output (I/O) interface 1806, a sensor component 1807, and a communication component 1808.

The processing component 1801 generally controls overall operations of the apparatus 1800, such as operations associated with display, phone calls, data communications, camera operations, and recording operations. The processing component 1801 may include one or more processors 1809 to execute instructions to complete all or part of the steps of the above methods. In addition, the processing component 1801 may include one or more modules which facilitate the interaction between the processing component 1801 and other components. For example, the processing component 1801 may include a multimedia module to facilitate the interaction between the multimedia component 1804 and the processing component 1801.

The memory 1802 is to store various types of data to support the operation of the apparatus 1800. Examples of such data include instructions for any application or method operated on the apparatus 1800, contact data, phonebook data, messages, pictures, videos, and so on. The memory 1802 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 1803 supplies power for different components of the apparatus 1800. The power supply component 1803 may include a power supply management system, one or more power supplies, and other components associated with generating, managing and distributing power for the apparatus 1800.

The multimedia component 1804 includes a screen providing an output interface between the apparatus 1800 and a user. In some examples, the screen may include a Liquid Crystal Display (LCD) and a Touch Panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a duration and a pressure associated with the touch or swipe. In some examples, the multimedia component 1804 may include a front camera and/or a rear camera. The front camera and/or rear camera may receive external multimedia data when the apparatus 1800 is in an operating mode, such as a photographing mode or a video mode. Each of the front camera and the rear camera may be a fixed optical lens system or have focal length and optical zooming capability.

The audio component 1805 is to output and/or input an audio signal. For example, the audio component 1805 includes a microphone (MIC). When the apparatus 1800 is in an operating mode, such as a call mode, a record mode and a voice recognition mode, the microphone is to receive an external audio signal. The received audio signal may be further stored in the memory 1802 or sent via the communication component 1808. In some examples, the audio component 1805 further includes a speaker for outputting an audio signal.

The I/O interface 1806 provides an interface between the processing component 1801 and a peripheral interface module. The above peripheral interface module may be a keyboard, a click wheel, buttons, or the like. These buttons may include but not limited to, a home button, a volume button, a start button and a lock button.

The sensor component 1807 includes one or more sensors to provide status assessments of various aspects for the apparatus 1800. For example, the sensor component 1807 may detect the on/off status of the apparatus 1800, and relative positioning of component, for example, the component is a display and a keypad of the apparatus 1800. The sensor component 1807 may also detect a change in position of the apparatus 1800 or a component of the apparatus 1800, a presence or absence of the contact between a user and the apparatus 1800, an orientation or an acceleration/deceleration of the apparatus 1800, and a change in temperature of the apparatus 1800. The sensor component 1807 may include a proximity sensor to detect the presence of a nearby object without any physical contact. The sensor component 1807 may further include an optical sensor, such as a Complementary Metal-Oxide-Semiconductor (CMOS) or Charged Coupled Device (CCD) image sensor which is used in imaging applications. In some examples, the sensor component 1807 may further include an acceleration sensor, a gyroscope sensor, a magnetic sensor, a pressure sensor, or a temperature sensor.

The communication component 1808 is to facilitate wired or wireless communication between the apparatus 1800 and other devices. The apparatus 1800 may access a wireless network based on a communication standard, such as Wi-Fi, 2G or 3G, or a combination thereof. In an example, the communication component 1808 receives a broadcast signal or broadcast related information from an external broadcast management system via a broadcast channel. In an example, the communication component 1808 may further include a Near Field Communication (NFC) module for promoting short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In an example, the apparatus 1800 may be implemented by one or more Application Specific Integrated Circuits (ASICs), Digital Signal Processors (DSPs), Digital Signal Processing Devices (DSPDs), programmable Logic Devices (PLDs), Field Programmable Gate Arrays (FPGAs), controllers, microcontrollers, microprocessors, or other electronic components for performing the above methods.

In an example, there is further provided a non-transitory computer readable storage medium including instructions, such as the memory 1802 including instructions. The above instructions may be executed by the processor 1809 of the apparatus 1800 to complete the above method. For example, the non-transitory computer readable storage medium may be a Read-Only Memory (ROM), a Random Access Memory (RAM), a CD-ROM, a magnetic tape, a floppy disk, an optical data storage device, and so on.

When the instructions in the storage medium are executed by the processor, the apparatus 1800 is caused to execute any above method of configuring an operating mode for a multi-mode terminal.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

1. A method of configuring an operating mode for a multi-mode terminal, applied to a base station and comprising:
determining, from among a plurality of operating modes supported by the multi-mode terminal and reported from the multi-mode terminal, a target operating mode matching the multi-mode terminal;
determining target network configuration information corresponding to the target operating mode; and
sending the target network configuration information to the multi-mode terminal, so that the multi-mode terminal operates in the target operating mode after performing network configuration according to the target network configuration information.

2. The method according to claim 1, wherein the determining, from among the plurality of the operating modes supported by the multi-mode terminal and reported from the multi-mode terminal, the target operating mode matching the multi-mode terminal, comprises:
determining a current service requirement of the multi-mode terminal; and
determining, from among the plurality of the operating modes supported by the multi-mode terminal and reported from the multi-mode terminal, the target operating mode matching the service requirement.

3. The method according to claim 1, wherein the determining, from among the plurality of the operating modes supported by the multi-mode terminal and reported from the multi-mode terminal, the target operating mode matching the multi-mode terminal, comprises:
determining a target link with the best link quality from among a plurality of links according to current link qualities of the plurality of the links; and
determining, from among the plurality of the operating modes supported by the multi-mode terminal and reported from the multi-mode terminal, the target operating mode matching the target link.

4. The method according to claim 1, wherein the determining the target network configuration information corresponding to the target operating mode comprises:
determining the target network configuration information corresponding to the target operating mode, according to a pre-defined correspondence between operating mode and network configuration information,
wherein the network configuration information comprises at least one of configuration information of a media access control layer, configuration information of a radio link control layer, or configuration information of a packet data convergence protocol layer.

5. The method according to claim 1, wherein the sending the target network configuration information to the multi-mode terminal comprises:
sending the target network configuration information to the multi-mode terminal through radio resource control signaling.

6. The method according to claim 1, wherein after the determining the target operating mode matching the multi-mode terminal, the method further comprises:
determining a target index number corresponding to the target operating mode, according to a pre-defined correspondence between operating mode and index number; and
sending the target index number to the multi-mode terminal, so that the multi-mode terminal operates in the target operating mode after performing network configuration according to target network configuration information corresponding to the target index number based on a pre-defined correspondence between index number and network configuration information.

7. A method of configuring an operating mode for a multi-mode terminal, applied to the multi-mode terminal and comprising:
reporting a plurality of operating modes supported by the multi-mode terminal to a base station;
receiving target network configuration information sent by the base station, wherein the target network configuration information is network configuration information corresponding to a target operating mode, and the target operating mode is an operating mode matching the multi-mode terminal which is determined by the base station from among the plurality of the operating modes; and
after performing network configuration according to the target network configuration information, operating in the target operating mode.

8. The method according to claim 7, wherein after the reporting the plurality of the operating modes supported by the multi-mode terminal to the base station, the method further comprises:
receiving a target index number sent by the base station, wherein the target index number is an index number corresponding to a target operating mode, and the target operating mode is an operating mode matching the multi-mode terminal which is determined by the base station from among the plurality of the operating modes;
determining target network configuration information corresponding to the target index number, according to a pre-defined correspondence between index number and network configuration information; and
upon determining the target network configuration information, performing the operation of operating in the target operating mode after performing the network configuration according to the target network configuration information.

9.-18 (canceled)

19. An apparatus of configuring an operating mode for a multi-mode terminal, applied to a base station and comprising:
a processor; and
a memory storing instructions executable by the processor,
wherein the processor is configured to:
determine, from among a plurality of operating mode supported by the multi-mode terminal and reported from the multi-mode terminal, a target operating mode matching the multi-mode terminal;
determine target network configuration information corresponding to the target operating mode; and
send the target network configuration information to the multi-mode terminal, so that the multi-mode terminal operates in the target operating mode after performing network configuration according to the target network configuration information.

20. An apparatus of configuring an operating mode for a multi-mode terminal, applied to the multi-mode terminal and comprising:
a processor; and
a memory storing instructions executable by the processor,
wherein the processor is configured to:
report a plurality of operating modes supported by the multi-mode terminal to a base station;
receive target network configuration information sent by the base station, wherein the target network configuration information is network configuration information corresponding to a target operating mode, and the target operating mode is an operating mode matching the multi-mode terminal which is determined by the base station from among the plurality of the operating modes; and
after performing network configuration according to the target network configuration information, operate in the target operating mode.

21. The apparatus according to claim 19, wherein the determining, from among the plurality of the operating modes supported by the multi-mode terminal and reported from the multi-mode terminal, the target operating mode matching the multi-mode terminal, comprises:
determining a current service requirement of the multi-mode terminal; and
determining, from among the plurality of the operating modes supported by the multi-mode terminal and reported from the multi-mode terminal, the target operating mode matching the service requirement.

22. The apparatus according to claim 19, wherein the determining, from among the plurality of the operating modes supported by the multi-mode terminal and reported from the multi-mode terminal, the target operating mode matching the multi-mode terminal, comprises:
determining a target link with the best link quality from among a plurality of links according to current link qualities of the plurality of the links; and
determining, from among the plurality of the operating modes supported by the multi-mode terminal and reported from the multi-mode terminal, the target operating mode matching the target link.

23. The apparatus according to claim 19, wherein the determining the target network configuration information corresponding to the target operating mode comprises:
determining the target network configuration information corresponding to the target operating mode, according to a pre-defined correspondence between operating mode and network configuration information,
wherein the network configuration information comprises at least one of configuration information of a media access control layer, configuration information of a radio link control layer, or configuration information of a packet data convergence protocol layer.

24. The apparatus according to claim 19, wherein the sending the target network configuration information to the multi-mode terminal comprises:
sending the target network configuration information to the multi-mode terminal through radio resource control signaling.

25. The apparatus according to claim 19, wherein after the determining the target operating mode matching the multi-mode terminal, the processor is further configured to:
determine a target index number corresponding to the target operating mode, according to a pre-defined correspondence between operating mode and index number; and
send the target index number to the multi-mode terminal, so that the multi-mode terminal operates in the target operating mode after performing network configuration according to target network configuration information corresponding to the target index number based on a pre-defined correspondence between index number and network configuration information.

26. The apparatus according to claim 20, wherein after the reporting the plurality of the operating modes supported by the multi-mode terminal to the base station, the processor is further configured to:
receive a target index number sent by the base station, wherein the target index number is an index number corresponding to a target operating mode, and the target operating mode is an operating mode matching the multi-mode terminal which is determined by the base station from among the plurality of the operating modes;
determine target network configuration information corresponding to the target index number, according to a pre-defined correspondence between index number and network configuration information; and
upon determining the target network configuration information, perform the operation of operating in the target operating mode after performing the network configuration according to the target network configuration information.

27. A base station implementing the method of claim 1, wherein the base station is configured to:
dynamically determine the target operating mode matching the multi-mode terminal in the plurality of the operating modes supported by the multi-mode terminal, thereby realizing a high availability of the multi-mode terminal; and
send the target network configuration information corresponding to the target operating mode to the multi-mode terminal through the radio resource control signaling.

28. The base station of claim 27, wherein the base station is further configured to send the target index number corresponding to the target operating mode to the multi-mode terminal after determining the target operating mode matching the multi-mode terminal, thereby facilitating the multi-mode terminal determining the target network configuration information corresponding to the target index number according to the pre-defined correspondence between index number and the network configuration information, and saving signaling resources between the base station and the multi-mode terminal.

29. A communication system comprising the base station of claim 28, further comprising the multi-mode terminal, wherein:
multi-mode terminal is configured to report the plurality of the operating modes supported by the multi-mode terminal to the base station;
the base station is configured to determine the target operating mode matching the multi-mode terminal in the plurality of the operating modes;
the multi-mode terminal is configured to receive the target network configuration information that is returned by the base station and corresponds to the target operating mode, such that the multi-mode terminal can operate in the target operating mode after performing network configuration according to the target network configuration information, thereby realizing configuring a target operating mode matching the multi-mode terminal.

30. The system of claim 29, wherein the multi-mode terminal is further configured to:
receive the target index number returned by the base station after reporting the plurality of the operating modes supported by the multi-mode terminal to the base station;
determine the target network configuration information corresponding to the target index number according to the pre-defined correspondence between index number and network configuration information;
operate in the target operating mode after performing network configuration according to the target network configuration information, thereby determining the corresponding target network configuration information upon only receiving the target index number from the base station, and saving signaling resources between the base station and the multi-mode terminal.
